(19) United States
(12) Patent Application Publication
(10) Pub. No.: US 2022/0398837 A1
(43) Pub. Date: Dec. 15, 2022

(54) METHOD FOR CALCULATING A QUALITY MEASURE FOR ASSESSING AN OBJECT DETECTION ALGORITHM

(71) Applicant: Robert Bosch GmbH, Stuttgart (DE)

(72) Inventors: Oliver Willers, Korb (DE); Sebastian Sudholt, Besigheim (DE)

(21) Appl. No.: 17/777,222

(22) PCT Filed: Oct. 29, 2020
(86) PCT No.: PCT/EP2020/080377

§ 371 Date: May 16, 2022

(30) Foreign Application Priority Data
Nov. 28, 2019 (DE) 10 2019 218 483.9

(51) Int. Cl. G06V 10/98; G06V 20/58; G06V 30/414

(52) U.S. Cl. CPC G06V 10/993; G06V 20/58; G06V 30/414

(57) ABSTRACT

A method for calculating a quality measure of a computer-implemented object detection algorithm, which may be used, in particular, for enabling the object detection algorithm for semi-automated, highly-automated or fully-automated robots. The method includes: assigning ascertained object detections to annotations, the object detections and/or the annotations corresponding to bounding boxes; determining deviations, in particular, distances of the annotations with respect to their assigned object detections; calculating the quality measure of the object detection algorithm based on the determined deviations, the quality measure representing a probability with which a deviation of an object detection from the annotation assigned to it exceeds or falls below a predefined threshold value.

### FIELD

The present invention relates to a method for calculating a quality measure for assessing a computer-implemented object detection algorithm, to a device configured for carrying out the method, to a computer program for carrying out the method, as well as to a machine-readable memory medium, on which this computer program is stored.

### BACKGROUND INFORMATION

Computer-implemented object detection algorithms are frequently used as part of a surroundings recognition of semi-automated, highly-automated, or fully-automated robots, in particular, vehicles operated in an automated manner. The algorithms used for this purpose are not perfect and may cause—more or less serious—erroneous detections. For example, an object detection algorithm in a vehicle operated in an automated manner may detect an object at a position other than where it is actually located and generate an erroneous surroundings model as a result. To enable such a system, it is therefore essential that the quality of the object detection algorithm is assessed and classified as sufficiently good.

To assess the object detection algorithm, average metrics, for example, the Intersection over Union, are generally used. From a safety perspective, however, average metrics are critical, since they assess on average the safest and riskiest behavior. Thus, for enabling a safety-critical product, these average metrics are no longer sufficient.

### SUMMARY

The present invention provides a computer-implemented method for calculating a quality measure of a computer-implemented object detection algorithm, which may be used, in particular, for enabling the object detection algorithm for semi-automated, highly-automated or fully-automated robots. In accordance with an example embodiment of the present invention, the method includes the following steps:
assigning ascertained object detections to annotations, the object detections and/or the annotations corresponding to bounding boxes;
determining deviations, in particular, distances, of the annotations with respect to their assigned object detections;
calculating the quality measure of the object detection algorithm based on the determined deviations, the quality measure representing a probability with which a deviation of an object detection from the annotation assigned to it exceeds or falls below a predefined threshold value.

In one optional step, the object detection algorithm may be enabled for use, in particular, for use in a robot operated in an at least semi-automated manner if it exceeds or falls below a predefined quality measure threshold value.

A robot may be understood to mean, for example, an industrial robot, an automated work machine or a vehicle operated in an automated manner. This may be understood to mean, in particular, a semi-automated, highly-automated or fully-automated vehicle, which is able to carry out driving operations at least temporarily without human interventions, in particular, adaptations of the longitudinal movements and/or lateral movements.

Data sets including annotations, in particular, are used for the method, annotations being understood to mean, in particular, bounding boxes. A bounding box may be understood to mean, in particular, a rectangle that encloses an object to be detected. For example, in the case of a video-based person detection, the bounding box is able to mark an area of an image in which a person is located. Alternatively, the bounding box may also be cuboid if objects in 3-dimensional space are to be detected. This may be useful, for example, if in the aforementioned example the position coordinates of the person in the real world are to be directly detected. Multiple objects to be detected and thus multiple annotations per datum of the data set may be present. For example, multiple persons may be seen on an image, all of which are to be detected.

Different data may be used. Image data recorded by one or multiple cameras, in particular, may be used. Data from other sensors, for example, from radar sensors, LIDAR sensors or ultrasonic sensors or microphones may, however, also be used. When using acoustic signals, it is possible to use, in particular, visualized noise spectra or the like as a basis for the object recognition.

The origin of the annotations may differ. If, for example, data sets are drawn from external sources, such as the Internet, they are frequently already provided with annotations, which may then be read out accordingly. Alternatively, the annotation may be created manually and linked to the data set. One further alternative is the automatic and/or semi-automatic creation of annotations. In the case of the semi-automatic annotation, images are labeled by an annotation algorithm, merely the correctness of the label being checked by a human in a second step.

The objective of the object detection algorithm is to detect objects as accurately as possible. For this purpose, the object detection algorithm calculates object detections, object detections being understood to mean, in particular, bounding boxes. In general, annotations as well as object detections may be represented by bounding boxes. The difference is that the bounding box of the annotation determines an object to be detected, whereas the bounding box of the object detection represents a bounding box ascertained by the object detection algorithm.

In order to determine how accurate the object detections of a given object detection algorithm are, the latter may initially be applied to a selected data set in order to calculate object detections for the data set. The object detections thus generated may be subsequently assigned to the annotations of the data set. This may be carried out by assigning an annotation to the object detection, which exhibits the greatest overlap with this annotation. Alternatively, the distance of an object detection to an annotation may be utilized as an assignment criterion by assigning an annotation to the object detection, which exhibits the shortest distance to it.

Once the assignment has been carried out, three possible situations result. An object detection has not been assigned to any annotation, for example, because it exhibits no overlap with any of the annotations. This is referred to as a false positive. The second possibility is that an annotation has been assigned no object detection. This is referred to as a false negative.

The third case is that an assignment takes place and there is a pair of object detection and annotation. This case is referred to as a match.

For all pairs of object detections and annotations that fulfill the third case, a quality measure may now be determined, which reflects the accuracy with which an object detection recognizes an annotation and thus an object to be detected.

Quality measure may be understood below to mean a probability, with which the distance of an object detection to the annotation assigned to it falls below a predefined distance threshold value. A distance in this case may be understood to mean a distance between a point on an edge of an object detection and a point on an edge of the associated annotation. It may, in particular, be the shortest or longest distance between the distance of the edge of an object detection and of the associated annotation.

An advantage of the present invention is that a probability may be ascertained with which the object detection algorithm may cause a safety risk in the case of object detections. The safety risk may be understood here to mean a probability that the object detections no longer completely enclose their correspondingly assigned annotations. This case is particularly critical for robots, drones and other autonomously acting vehicles that use an object detection algorithm as part of their surroundings modeling and motion planning. Conversely, the present invention may be utilized in order to classify an object detection algorithm in the case of an object detection as safe when the ascertained probability falls below a predefined value.

In one further specific example embodiment of the present invention, the deviation is a distance between a point of the object detection to a point of its assigned annotation.

An advantage of this specific example embodiment of the present invention is that the object detection algorithm is not limited to object detections, whose sides are in parallel to the sides of the annotations. For example, the object detection algorithm may output an object detection, which is rotated in relation to the annotation assigned to it. In this case, the deviation may be understood to be a distance between one corner of the annotation and one side of the object detection.

In one further specific example embodiment of the method of the present invention, the deviation represents a shift between a point of the object detection to a point of its assigned annotation, the shift being a signed scalar, whose value represents a distance and its sign a direction in which the point of the annotation is shifted from the point of the object detection.

An advantage of this extension is that it may be determined via the smallest shift, for example, to what extent the annotation is situated within the object detection to which it is assigned, or otherwise how far the annotation projects out of the object detection. In the event that the object detection completely encloses the annotation, the smallest shift is greater than zero. In the event that parts of the annotation are situated outside the object detection, the smallest shift is less than zero. This may be used to determine how likely it is that parts of the annotation or the entire annotation are situated outside the object detection.

In one further specific example embodiment of the method of the present invention, the deviation corresponds to the smallest shift of a set of shifts.

An advantage of this specific embodiment of the present invention is that a given object detection may be characterized by its—from a safety perspective—potentially riskiest deviation with respect to the annotation. In terms of a safety argument, the riskiest deviations of all object detections may be used and statistically evaluated.

In one further specific example embodiment of the method of the present invention, the set of shifts is made up of shifts of the sides of the annotation to the corresponding sides of the assigned object detection, the shifts being orthogonal to the respective side. Corresponding sides are understood to mean the sides of an object detection and annotation, which symbolize identical boundaries. In 2-dimensional object detections and annotations, these are the left, right, upper and lower sides, respectively. For example, the left side of an object detection corresponds to the left side of the annotation assigned to it. In order to determine the smallest shift between corresponding sides, the shift in parallel to the respective annotation side, with which the side of the corresponding side of the object detection is shifted, is ascertained for each pair of corresponding sides. The smallest shift is then the shift of the shortest length.

An advantage of this extension is that it may be determined to what extent the annotation maximally projects from the object detection. In this way, an estimation of the—from a safety perspective—riskiest deviation may be determined for each pair of annotation and assigned object detection. Conversely, it may be determined how much latitude the object detection algorithm still has until it commits a potentially safety-critical error.

In one further specific example embodiment of the method of the present invention, the deviation is understood to mean an area that corresponds to the part of the annotation that exhibits no overlap with the object detection. This advantage of this specific embodiment is that the area may potentially better describe to what extent multiple deviations (for example, height and width) of the annotation may be safety critical. In three-dimensional objects, the deviation may be accordingly indicated by a volume, the deviation being represented by the volume that exhibits no overlap with the volume of the object detection.

In one further specific example embodiment of the method of the present invention, the calculation of the probability takes place based on a model, which is ascertained based on the determined deviations.

The model may, for example, be a form of a probability distribution. The ascertainment of this model may also be based on the determined deviations. For example, the parameters thereof may be ascertained based on a conventional method, in particular, Maximum Likelihood Estimation or Bayesian parameter estimation. Alternatively, the parameters may be set based on expert knowledge in such a way that the model shows a desirable behavior. The advantage is that by using a model thus selected, it is possible to also integrate suitable presuppositions into the determination of the probability.

Alternatively, the model may extract knowledge solely from the determined deviations and output a probability accordingly. Conventional machine learning methods, in particular, neural networks may be used for this purpose.

An advantage is that by using models of this type, it is possible to also incorporate other and/or fewer presuppositions into the probability ascertainment, and pieces of information are extracted solely on the basis of the data, i.e., of the determined deviations. This may be meaningful if, for example, no meaningful presuppositions with respect to the distribution of the deviations are known.

In one further specific example embodiment of the present invention, the above-described model is a parameterizable model, in particular, a parameterizable probability distribution, whose parameters may be ascertained from the determined deviations.

An advantage of this specific embodiment is that the presuppositions about the family of the selected probability distribution are clearly formulated, and the actual distribution of the determined deviations may be easily determined via conventional methods, for example, with the aid of Maximum Likelihood Estimation. Alternatively, Bayesian methods may be used in order to also incorporate additional presuppositions with respect to the parameters into the determination.

In one further specific example embodiment of the present invention, the above-described parameterizable model is one expression of a general extreme value distribution, the parameters defining the specific distribution.

An advantage of this specific example embodiment of the method of the present invention is that general extreme value distributions model rare events very well. It may generally be assumed that the above-described deviations follow an extreme value distribution. In order to substantiate this in a specific case, statistical tests, in particular, a Kolmogorow-Smirnoff test, may be used.

In addition, a computer-implemented method is provided in accordance with the present invention, which may be used for adapting a computer-implemented object detection algorithm for ascertaining object detections. In accordance with an example embodiment of the present invention, the method includes the following steps:
ascertaining annotations of objects to be detected with the aid of the object detection algorithm;
ascertaining object detections with the aid of the object detection algorithm;
calculating a quality measure of the object detection algorithm according to one of the above-described methods for calculating a quality measure of an object detection algorithm;
adapting the detection algorithm based on the calculated quality measure in such a way that a renewed execution of the object detection algorithm results in a scaling of the object detections ascertained with the aid of the object detection algorithm.

The ascertainment of the annotations and object detections, as well as the calculation of the quality measure in this case may take place similarly to the explanations regarding the above-described methods. Data sets, for example, may be used, from which the annotations are extracted. In this method, the objects to be detected are subsequently predicated by object detections using the object detection algorithm. The object detections are subsequently assigned to the annotations and one of the above-described methods for determining a quality measure is applied in order to assess the predictions.

For the step of adapting the object detection algorithm, the calculated quality measure may be used in such a way that the underlying object detection algorithm becomes safer. As described above, a predicted object detection of an object detection algorithm may be understood to be safety-critical if the annotation assigned to it is situated completely or partially outside the object detection. In order to change the object detection algorithm so that it is safer, the predicted object detection may, for example, be scaled in such a way—i.e., changed in its form and size—that the assigned annotation is completely enclosed.

An advantage of this method is that an object detection algorithm may be measurably adapted by increasing the quality measure in such a way that the object detection algorithm enables a better or safer detection of objects. The method may therefore be used as one component of a safety argument for enabling the product, for example, of an automated driving function and/or of a driver assistance function, which is based on the object detection algorithm.

In one further specific example embodiment of the present invention, the steps for ascertaining the object detections, calculating the quality measure and adapting the object detection algorithm using the respectively adapted object detection algorithm are repeated until the quality measure falls below or exceeds a predefined quality value and/or a predefined number of repetitions has been reached.

An advantage of this specific example embodiment is that object detection algorithms based on iterative methods may be very easily adapted in order to increase the safety of the predicted object detections.

In one further specific example embodiment of the method of the present invention, the object detection algorithm is based on a parameterizable model, in particular, on a neural network.

An advantage of this specific example embodiment of the present invention is that the instantaneously most performant object detection algorithms are based on neural networks. This specific embodiment allows the safety of a neural network to be able to be assessed via one of the above-described quality measures.

In one further specific example embodiment of the present invention, the scaling takes place based on properties of the ascertained object detections, in particular, on the size, on the proportions and/or on the position in the image. For example, it may be established that smaller object detections must be scaled differently than larger ones, since deviations of the object detections with respect to the assigned annotations are more safety-critical for larger annotations than for smaller ones and/or vice versa. Alternatively and/or in addition, the position of the object detection may also be used for determining the scaling. In the case of an autonomous vehicle, it may be determined, for example, that objects at the upper edge of a video image are further away from the vehicle itself and are therefore less safety-critical.

In one further specific example embodiment of the method of the present invention, the scaling takes place independently of the ascertained object detections, in particular, based on a predefined factor.

An advantage of this specific embodiment is that the factor may be optimized without assumptions based solely on the quality measure and represents a computationally economical measure by which an existing object detection algorithm may be made measurably safer in a simple and rapid manner.

In one further specific example embodiment of the method of the present invention, the object detection algorithm is based on a parameterizable model, in particular, on a neural network, the adaptation being based on a change of the parameters of the parameterizable model, including the steps:
ascertaining scaled annotations, based on the ascertained annotations;
ascertaining object detections with the aid of the detection algorithm;
assigning the object detections to the scaled annotations, based on the ascertained annotations;
ascertaining an error between the object detections and the scaled annotations assigned to them;
reducing the error by adapting the parameters.

A main feature of this specific example embodiment of the method of the present invention is that a neural network is trained in such a way that it already outputs scaled object detections that no longer require any downstream scaling in order to enclose the assigned annotation. For this purpose, scaled annotations are initially required. Scaled annotations are understood to mean annotations that have been generated by scaling from the originally extracted annotations. These scaled annotations may then be used for training the neural network, via which the neural network is guided to already intrinsically carry out the scaling.

It is empirically proven that neural networks currently represent the most performant object detection algorithms. The advantage of this specific embodiment, therefore, is that in addition to the high performance, it is possible to achieve a high degree of safety with respect to the prediction of object detections.

In one further specific example embodiment of the method of the present invention, the individual steps of the above-described specific embodiment including the respectively adapted parameters are repeated until a predefined error threshold value is fallen below and/or until a predefined number of repetitions is reached.

An advantage of this specific example embodiment of the present invention is that the neural network may be iteratively adapted. This iterative process for training neural networks allows for the best prediction capabilities.

In addition, a computer program is provide in accordance with the present invention, which includes commands which, upon execution of the computer program by a computer, prompt the computer to carry out one of the above-cited methods.

In addition, a machine-readable memory medium is provide in accordance with the present invention, on which this computer program is stored.

In addition, a device is provided in accordance with the present invention, which is configured to carry out one of the above-described methods.

### BRIEF DESCRIPTION OF THE DRAWINGS

FIG. 1 schematically shows a method diagram for determining a quality measure of the object detection algorithm, in accordance with an example embodiment of the present invention.

FIG. 2 shows by way of example the relationships between annotation, object detection and scaling of an object detection, in accordance with an example embodiment of the present invention.

FIG. 3 shows by way of example the determination of shifts of corresponding sides of an annotation and of the object detection assigned to it, in accordance with an example embodiment of the present invention.

FIG. 4 schematically shows a general extreme value distribution including a threshold value, in accordance with an example embodiment of the present invention.

FIG. 5 chematically shows the sequence for improving a quality measure of an object detection algorithm, in accordance with an example embodiment of the present invention.

### DETAILED DESCRIPTION OF EXAMPLE EMBODIMENTS

In one first exemplary embodiment, a quality measure of an object detection algorithm is determined with the aid of a computer-implemented method. The object detection algorithm in this case is designed in such a way that it is able to recognize predefined objects by marking these objects with a bounding box in image data recorded with the aid of a camera. This is represented schematically, for example, in FIG. 2a, in which a vehicle including an annotation 201 and a bounding box 202a determined with the aid of the object detection algorithm are depicted.

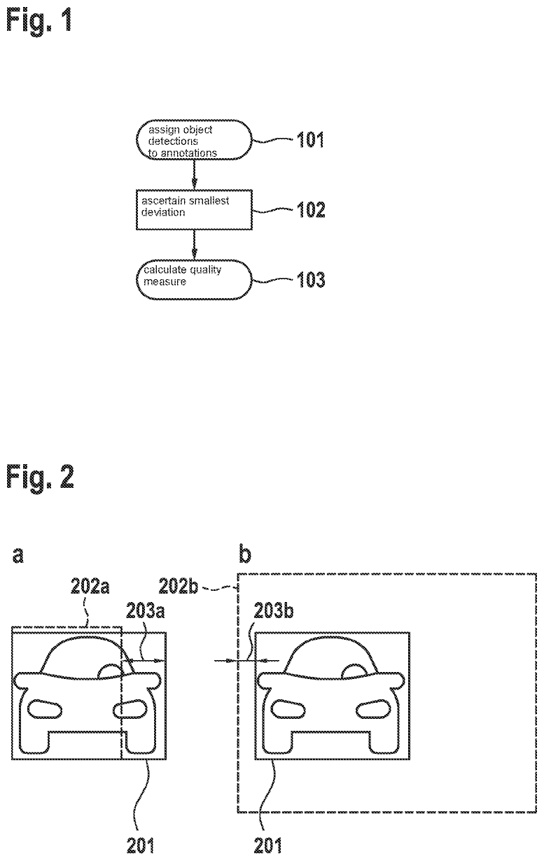

In order to be able to determine a measure for the quality of the algorithm or of an accuracy of the object recognition, a set of images is used in this exemplary embodiment, in which objects are annotated, and the object detection algorithm has determined bounding boxes for the annotated objects. This data set is used for the method for determining a quality measure of the object recognition algorithm schematically represented in FIG. 1.

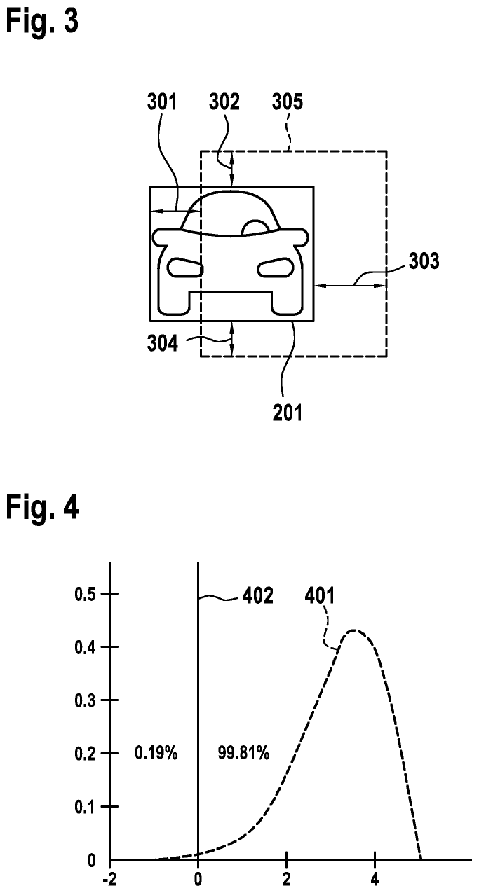

In step 101 of this method, the object detections, which have been determined with the aid of the object detection algorithm, are assigned to the annotations 201 encompassed by the image data. In this case, an annotation may in general project beyond an associated object detection 202a; this case is shown by way of example in FIG. 2a. The other possibility is that the annotation is completely enclosed by object detection 202b, which is schematically shown in FIG. 2b and FIG. 3. The specific case in which the annotation corresponds exactly to the object detection may be optionally assigned to one of the two categories shown in FIG. 2 for the following steps. The assignment of the annotation to an object detection takes place in this exemplary embodiment via the so-called Intersection over Union, i.e., the ratio of overlap of the two bounding boxes to the area of the union of the two bounding boxes.

(In alternative exemplary embodiments, at this point the distance of the midpoint of the two bounding boxes may also be used instead, in order to carry out the assignment.)

In step 102, the smallest deviation is ascertained for each pair of annotation and assigned object detection. The smallest deviation in this case is ascertained from a set of deviations of the object detections from the associated annotations, which is represented schematically in FIG. 3. The deviations in this exemplary embodiment are a respective shift of corresponding sides of an object detection and of the annotation assigned to it. This means that shifts for the left 301, upper 302, right 303 and lower 304 corresponding sides are ascertained. The shifts in this case are always in parallel to the corresponding side of annotation 201. In addition, the sign of a shift indicates the direction in which the object detection is shifted from annotation 201. In the event that annotation 201 projects at one side from the object detection, the corresponding shift is negative 301. Otherwise, the shift is positive 302, 303, 304. The smallest of the four shifts 301, 302, 303, 304 is subsequently ascertained.

In step 103, the quality measure is calculated. For this purpose, a model 401 that represents the distribution of the deviations is ascertained from the deviations ascertained in step 102. In this exemplary embodiment, a general extreme value distribution is used for this purpose.

The parameters of the general extreme value distribution are ascertained by using the method of Maximum Likelihood Estimation.

To calculate the quality measure, the cumulative distribution function of the general extreme value distribution is evaluated 402 at value 0. This step is schematically represented in FIG. 4. In the figure, the shift is plotted on the x-axis and the probability density of the extreme value distribution is plotted on the y-axis. The result of the evaluation corresponds to the probability that an annotation projects from the object detection assigned to it.

In one second exemplary embodiment, the same steps are carried out as in the first exemplary embodiment, in step 103, however, a Bayesian parameter estimation is carried out instead of the Maximum Likelihood Estimation.

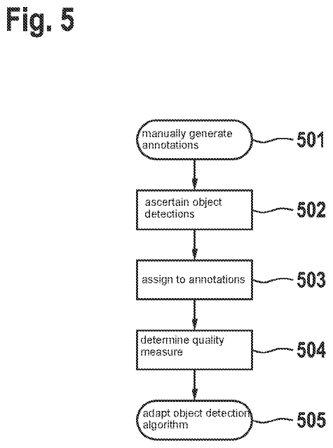

In one third exemplary embodiment, which is schematically shown in FIG. 5, an object detection algorithm is changed in such a way that it becomes safer.

For this purpose, annotations are generated manually in step 501 for a data set of camera-based sensor data. Alternatively, the annotations may also be semi-automatically or fully-automatically generated.

In step 502, object detections are ascertained for the sensor data using the object detection algorithm, which are then assigned to the annotations in step 503. The assignment in this case takes place as in the first exemplary embodiment.

The quality measure of the object detection algorithm is determined in step 504. This takes place as in the first exemplary embodiment.

In step 505, the object detection algorithm is adapted in such a way that the probability of an annotation projecting from the object detection assigned to it becomes smaller. For this purpose, all object detections are scaled using a fixed factor in such a way that they enclose the annotation assigned to it.

In one fourth exemplary embodiment, the same steps are carried out as in the third exemplary embodiment, however, LIDAR-based sensor data are used instead of camera-based sensor data. The remaining steps proceed similarly.

In one fifth exemplary embodiment, the same steps proceed as in the third exemplary embodiment, step 505 being modified as follows: the object detections are scaled using a fixed factor and the quality measure for the scaled object detections is calculated. If the quality measure does not meet a predefined threshold value, the object detections already scaled are scaled using a factor in such a way that the object detection becomes greater. This adaptation of the size with the aid of a scaling factor is carried out until the quality measure falls below a predefined probability.

In one sixth exemplary embodiment, the object detection algorithm is based on a neural network. The same steps are carried out as in the third exemplary embodiment, step 505 being modified as follows: the neural network is trained using sensor data and annotations of a second data set in such a way that it outputs intrinsically larger object detections. For this purpose, the annotations of the second data set are scaled in such a way that they become larger. During subsequent training using the scaled annotations, the neural network then learns to predict the larger object detections. After the training, the changed neural network is applied again to the first data set and the quality measure is newly determined. If the quality measure is above a predefined probability value, the neural network is trained on the second data set using even larger scaled annotations. The adaptation of the neural network and evaluation of the quality measure is repeatedly carried out until the quality measure falls below the predefined probability value.

1-15. (canceled)

16. A method for calculating a quality measure of a computer-implemented object detection algorithm, for enabling the object detection algorithm for semi-automated, highly-automated or fully-automated robots, including the following steps:
assigning ascertained object detections to annotations, the object detections and/or the annotations corresponding to bounding boxes;
determining deviations including distances of the annotations with respect to their assigned object detections;
calculating the quality measure of the object detection algorithm based on the determined deviations, the quality measure representing a probability with which a deviation of an object detection from an annotation assigned to it exceeds or falls below a predefined threshold value.

17. The method as recited in claim 16, wherein each deviation represents a shift between a point of the object detection to a point of its assigned annotation, the shift being a signed scalar, whose value represents a distance and its sign a direction, in which the point of the annotation is shifted from the point of the object detection.

18. The method as recited in claim 17, wherein the deviation represents a smallest shift from a set of ascertained shifts.

19. The method as recited in claim 18, wherein the set is made up of sides of the annotation to corresponding sides of the assigned object detection and the shifts being orthogonal to the respective side.

20. The method as recited in claim 16, wherein each deviation represents an area that corresponds to a part of the annotation that exhibits no overlap with the object detection.

21. The method as recited in claim 16, wherein the calculation of the quality measure representing the probability is based on a model which is ascertained based on the determined deviations.

22. The method as recited in claim 21, wherein the model is a parameterizable model, the parameterizable model being a parameterizable probability distribution, whose parameters are ascertained from the determined deviations.

23. A method for adapting a computer-implemented object detection algorithm for ascertaining object detections, comprising the following steps:
a) ascertaining annotations of objects detected using the object detection algorithm;
b) ascertaining object detections using the object detection algorithm;
c) calculating a quality measure of the object detection algorithm by:
assigning the object detections to the annotations, the object detections and/or the annotations corresponding to bounding boxes,
determining deviations including distances of the annotations with respect to their assigned object detections, and
calculating the quality measure of the object detection algorithm based on the determined deviations, the quality measure representing a probability with which a deviation of an object detection from an annotation assigned to it exceeds or falls below a predefined threshold value;
d) adapting the object detection algorithm based on the calculated quality measure in such a way that a renewed execution of the object detection algorithm results in a scaling of the object detections ascertained using the object detection algorithm.

24. The method as recited in claim 23, wherein steps b through d are repeated using the respectively adapted object detection algorithm until the quality measure falls below or exceeds a predefined quality value and/or a predefined number of repetitions has been reached.

25. The method as recited in claim 23, wherein the scaling takes place based on properties of the ascertained object detection including size, and/or proportions and/or position in an image.

26. The method as recited in claim 23, wherein the scaling takes place independently of the ascertained object detections, and based on a predefined factor.

27. The method as recited in claim 23, wherein the object detection algorithm is based on a parameterizable model, the parameterizable model being a neural network, the adaptation being based on a change of parameters of the parameterizable model, including the steps:
e. ascertaining scaled annotations, based on the ascertained annotations;
f. ascertaining object detections using the object detection algorithm;
g. assigning the object detections to the scaled annotations, based on the ascertained annotations;
h. ascertaining an error between the object detections and the scaled annotations assigned to them;
i. reducing the error by adapting the parameters.

28. The method as recited in claim 27, wherein the steps f through i are repeated using the respectively adapted parameters until a predefined error threshold value is fallen below and/or until a predefined number of repetitions is achieved.

29. A non-transitory machine-readable memory medium on which is stored a computer program for calculating a quality measure of a computer-implemented object detection algorithm, for enabling the object detection algorithm for semi-automated, highly-automated or fully-automated robots, the computer program, when executed by a computer, causing the computer to perform the following steps:
assigning ascertained object detections to annotations, the object detections and/or the annotations corresponding to bounding boxes;
determining deviations including distances of the annotations with respect to their assigned object detections;
calculating the quality measure of the object detection algorithm based on the determined deviations, the quality measure representing a probability with which a deviation of an object detection from an annotation assigned to it exceeds or falls below a predefined threshold value.
